(19) United States
(12) Patent Application Publication
(10) Pub. No.: US 2025/0008239 A1
(43) Pub. Date: Jan. 2, 2025

(54) IMAGING ELEMENT AND IMAGING DEVICE

(71) Applicant: NIKON CORPORATION, Tokyo (JP)

(72) Inventors: Osamu SARUWATARI, Yokohama-shi (JP); Wataru FUNAMIZU, Yokohama-shi (JP); Shutaro KATO, Yokohama-shi (JP)

(73) Assignee: NIKON CORPORATION, Tokyo (JP)

(21) Appl. No.: 18/707,210

(22) PCT Filed: Nov. 2, 2022
(86) PCT No.: PCT/JP2022/041090

§ 371 Date: Jun. 28, 2024

(30) Foreign Application Priority Data
Nov. 5, 2021 (JP) 2021-181462

(51) Int. Cl. H04N 25/778; H04N 25/78

(52) U.S. Cl. CPC H04N 25/778; H04N 25/78

(57) ABSTRACT

An imaging element includes a storage unit that stores a pixel signal converted into a digital signal; a control line to which a control signal to read out the pixel signal stored in the storage unit is output; an output line to which the pixel signal read out from the storage unit is output; and an amplification unit that amplifies the pixel signal output to the output line. The output line may include a positive and negative pair of output lines connected to the amplification unit, the output line may be connected to one of a positive and negative pair of inputs of the amplification unit, and another of the inputs of the amplification unit may be connected to reference potential.

### BACKGROUND

### 1. Technical Field

The present invention relates to an imaging element and an imaging device.

### 2. Related Art

An imaging element is known which can process signals, in a parallel manner, each output from a plurality of pixels (for example, Patent Document 1). Conventionally, there has been a problem of an increase in consumption current due to parallel processing of signals from pixels.

### PRIOR ART DOCUMENT

### Patent Document

Patent Document 1: International publication number WO2013/129202

### GENERAL DISCLOSURE

In a first aspect of the present invention, an imaging element comprises a storage unit that stores a pixel signal converted into a digital signal; a control line to which a control signal to read out the pixel signal stored in the storage unit is output; an output line to which the pixel signal read out from the storage unit is output; and an amplification unit that amplifies the pixel signal output to the output line. The output line may include a positive and negative pair of output lines connected to the amplification unit. The amplification unit may be a differential amplification unit. The output line may be connected to one of a positive and negative pair of inputs of the amplification unit, and another of the inputs of the amplification unit may be connected to reference potential. The imaging element may further comprise a first partial output line to which a pixel signal read out from a plurality of storage units, each being identical to the storage unit, corresponding to a plurality of pixels is output. The imaging element may further comprise a first buffer, an input of which is connected to the first partial output line, and an output of which is connected to the output line. The imaging element may further comprise a second partial output line to which a pixel signal read out from another plurality of storage units, each being identical to the storage unit, corresponding to another plurality of pixels is output. The imaging element may further comprise a second buffer, an input of which is connected to the second partial output line, and an output of which is connected to the output line. The imaging element may further comprise a first partial output line to which a pixel signal read out from a plurality of storage units, each being identical to the storage unit, corresponding to a plurality of pixels is output. The imaging element may further comprise a first selection unit, an input of which is connected to the first partial output line, and an output of which is connected to the output line. The imaging element may further comprise a second partial output line to which a pixel signal read out from another plurality of storage units, each being identical to the storage unit, corresponding to another plurality of pixels is output. The imaging element may further comprise a second selection unit, an input of which is connected to the second partial output line, and an output of which is connected to the output line. A voltage applied to the output line may be smaller than a voltage applied to the first partial output line and the second partial output line. The control line may be connected to a plurality of storage units in common, each being identical to the storage unit, corresponding to a plurality of pixels, and the imaging element may further comprise a repeater that is disposed between the plurality of storage units in the control line and transfers the control signal.

In the second aspect of the present invention, an imaging device comprises the imaging element described above.

The summary clause does not necessarily describe all necessary features of the embodiments of the present invention. In addition, the invention may also be a sub-combination of the features described above.

### BRIEF DESCRIPTION OF THE DRAWINGS

FIG. 1 shows an overview of an imaging element 400 according to the present embodiment.

FIG. 2 shows an example of a flat layout of a first substrate 100.

FIG. 3 shows an example of a flat layout of a second substrate 200.

FIG. 4 shows an example of a circuit configuration of a pixel 112 and a pixel circuit 212.

FIG. 5 schematically illustrates a circuit for readout from a pixel memory 220.

FIG. 6 schematically illustrates, in more detail, the circuit for readout from a memory cell 221.

FIG. 7 is an example of a timing chart when reading out the signals stored in the memory cells 221, 222 of FIG. 6.

FIG. 8 schematically illustrates, in detail, another circuit for readout from the memory cell 221.

FIG. 9 schematically illustrates, in detail, still another circuit for readout from the memory cell 221.

FIG. 10 schematically illustrates, in detail, yet another circuit for readout from the memory cell 221.

FIG. 11 show an example of a timing chart when reading out the signals stored in the memory cell 221 of FIG. 10.

FIG. 12 schematically illustrates another circuit for readout from the pixel memory 220.

FIG. 13 is a block diagram showing a configuration example of an imaging device 500 according to an embodiment.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

In the present specification, the X-axis and the Y-axis are orthogonal to each other, and the Z-axis is orthogonal to the XY plane. The XYZ axes constitute a right-handed system. A direction parallel to the Z-axis may be referred to as a stacking direction of the imaging element 400. In the present specification, the terms “upper” and “lower” are not limited to the upper and lower direction in the direction of gravity. These terms just refer to relative directions in the Z-axis direction. Note that, in the present specification, an array in the X-axis direction is described as a “row” and an array in the Y-axis direction is described as a “column”, but the row-column direction is not limited thereto. In addition, the z-axis direction is defined as an optical axis direction in which a light is incident from a subject.

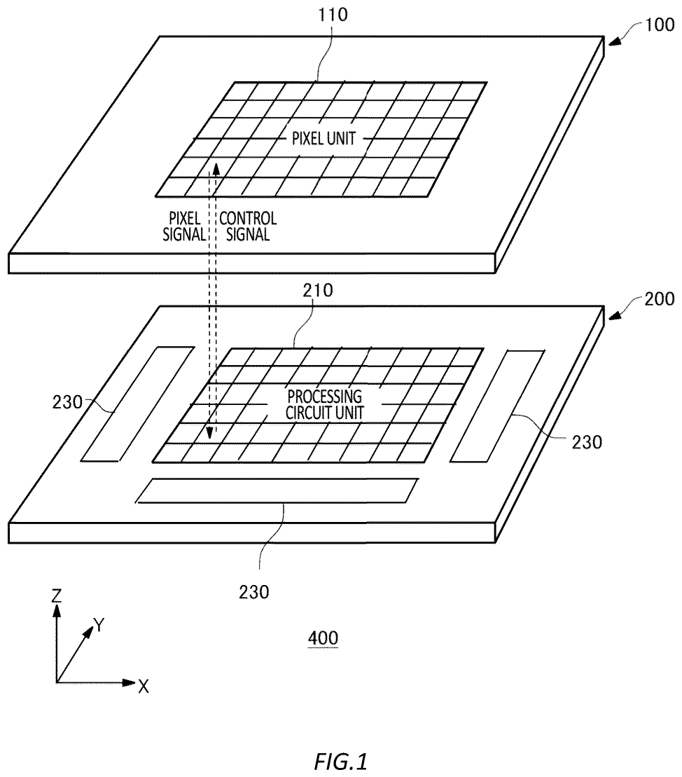

FIG. 1 shows an overview of an imaging element 400 according to the present embodiment. The imaging element 400 is configured to capture an image of a subject. The imaging element 400 is configured to generate image data of the captured subject. The imaging element 400 includes a first substrate 100 and a second substrate 200. As illustrated in FIG. 1, the first substrate 100 is stacked above the second substrate 200.

The first substrate 100 includes a pixel unit 110. The pixel unit 110 outputs a pixel signal based on an incident light. Note that, the first substrate 100 may be referred to as a pixel chip in some cases.

The second substrate 200 includes a processing circuit unit 210 and peripheral circuit unit 230. Note that, the second substrate 200 may be referred to as a signal processing chip in some cases.

A pixel signal output from the first substrate 100 is input to the processing circuit unit 210. The processing circuit unit 210 processes the input pixel signal. For example, the processing circuit unit 210 converts an analog signal into a digital signal. Specifically, the processing circuit unit 210 converts an input pixel signal into a digital signal. The processing circuit unit 210 may perform other kinds of signal processing.

The processing circuit unit 210 of the present example is arranged in a position, of the second substrate 200, that faces the pixel unit 110. That is, the processing circuit unit 210 is disposed so as to overlap at least partially with the pixel unit 110 in an optical axis direction. The processing circuit unit 210 may output, to the pixel unit 110, a control signal to control the driving of the pixel unit 110.

The peripheral circuit unit 230 controls the driving of the processing circuit unit 210. The peripheral circuit unit 230 is arranged in the periphery of the processing circuit unit 210 in the second substrate 200. In addition, the peripheral circuit unit 230 may be electrically connected to the first substrate 100 to control the driving of the pixel unit 110.

In addition to the first substrate 100 and the second substrate 200, the imaging element 400 may include a third substrate stacked on the second substrate 200. For example, the third substrate is a memory chip to perform image processing according to a signal output by the second substrate 200. In addition, a structure of the imaging element 400 may be of a back-side illumination type or a front-side illumination type. In the following descriptions, the back-side illumination type will be exemplified.

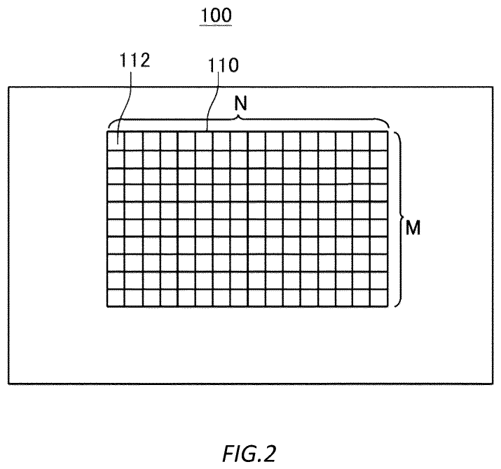

FIG. 2 shows an example of a flat layout of the first substrate 100. The pixel unit 110 is disposed near the center of the first substrate 100 on its surface.

The pixel unit 110 includes a plurality of pixels 112 arranged in line along a row direction and a column direction. The pixel unit 110 of the present example includes M×N pixels 112 (M and N are natural numbers). The illustrated M and N are different from each other in the present example, although they may be the same.

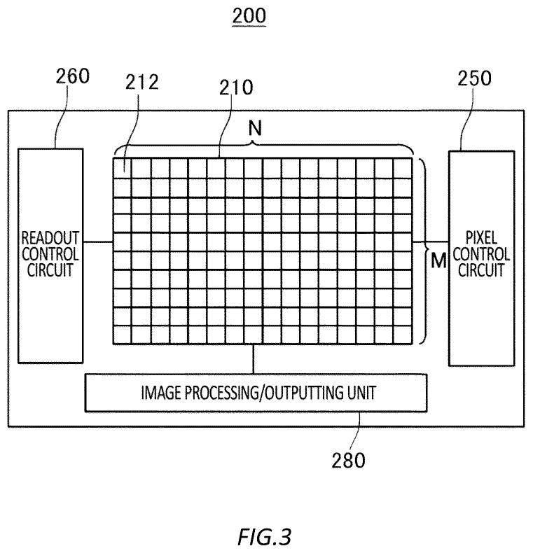

FIG. 3 shows an example of a flat layout of the second substrate 200. The processing circuit unit 210 is disposed near the center of the second substrate 200 on its surface.

The processing circuit unit 210 includes a plurality of pixel circuits 212 arranged in line along the row direction and the column direction. The processing circuit unit 210 of the present example includes M×N pixel circuits 212.

In the present embodiment, a pixel circuit 212 and a pixel 112 are disposed in a position overlapped with each other when viewed in the optical axis direction. In this case, areas of the pixel circuit 212 and the pixel 112, including margins between adjacent blocks, may be substantially the same.

The pixel circuit 212 controls the driving of the pixel 112 to which it is electrically connected. The pixel circuit 212 and pixel 112 being electrically connected may be referred to as “corresponding” to each other in some cases.

In the present embodiment, the pixel circuit 212 and the pixel 112 disposed in a position overlapped with each other are connected. However, instead of the pixel circuit 212 and the pixel 112 disposed in the overlapped position being connected, the pixel circuit 212 and the pixel 112 that are disposed in positions not being overlapped with each other may be connected.

A pixel control circuit 250, a readout control circuit 260 and an image processing/outputting unit 280 are disposed in the periphery of the processing circuit unit 210, each being an example of the peripheral circuit unit 230. The pixel control circuit 250 controls the pixel 112 and the pixel circuit 212. For example, the pixel control circuit 250 supplies a control signal for the pixel circuit 212 to perform A/D conversion of a signal from the pixel 112. In addition, the pixel control circuit 250 controls an exposure time of the pixel 112, for example. The readout control circuit 260 controls readout of a pixel signal stored in the pixel circuit 212 to output the pixel signal to the image processing/outputting unit 280.

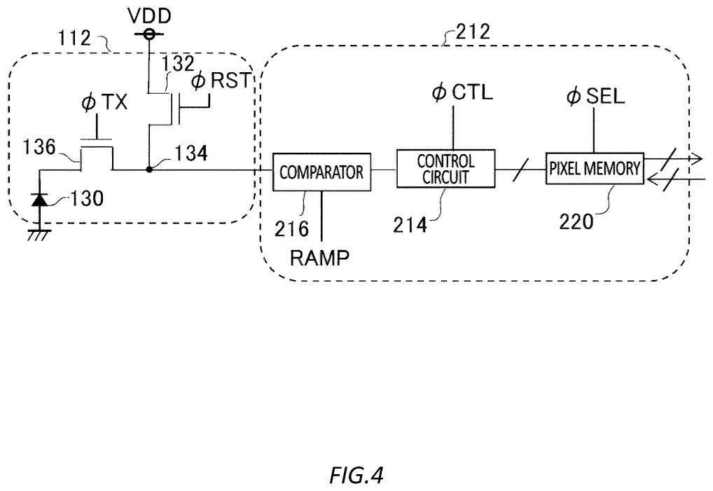

FIG. 4 shows an example of a circuit configuration of the pixel 112 and the pixel circuit 212. The pixel 112 includes an photoelectric conversion unit 130, a reset unit 132, an accumulation unit 134, and a transfer unit 136.

The photoelectric conversion unit 130 includes a photoelectric conversion function to convert light into electric charges and an accumulation function to accumulate the electric charges converted from the light. The photoelectric conversion unit 130 is, for example, a photo diode.

The accumulation unit 134 converts the electric charges generated by the photoelectric conversion unit 130 into voltage according to an amount of the electric charges. The accumulation unit 134 is an example of a floating diffusion (FD).

The reset unit 132 discharges, based on a control signal ϕRST, the electric charges in the accumulation unit 134 to a power supply wiring line through which a predetermined power supply voltage VDD is supplied. A gate terminal of the reset unit 132 is connected to the pixel control circuit 250.

The transfer unit 136 transfers, based on a control signal ϕTX, the electric charges accumulated in the photoelectric conversion unit 130 to the accumulation unit 134. In addition, the transfer unit 136 resets, based on the control signal ϕTX, the electric charges accumulated in the photoelectric conversion unit 130. For example, the transfer unit 136 resets the electric charges accumulated in the photoelectric conversion unit 130 to zero by simultaneously supplying the control signal ϕTX and the control signal ϕRST. The transfer unit 136 is an example of a transfer gate for transferring the electric charges of the photoelectric conversion unit 130. In other words, the transfer unit 136 as a gate, the photoelectric conversion unit 130 as a source, and the accumulation unit 134 as a drain constitute a so-called transfer transistor.

The pixel circuit 212 includes a comparator 216, a control circuit 214, and a pixel memory 220. The comparator 216 compares a voltage of the accumulation unit 134 and a reference voltage RAMP supplied by the pixel control circuit 250, and outputs the comparison result to the control circuit 214. For example, the comparator 216 is constituted by a differential pair. In addition, a source follower circuit may be disposed between the comparator 216 and the accumulation unit 134, for example. The control circuit 214 controls the pixel memory 220 based on a signal from the comparator 216 and a signal of ϕCTL.

The pixel memory 220 stores the pixel signal converted into a digital signal. For example, the pixel memory 220 receives a count signal supplied by the pixel control circuit 250, and when the control signal output by the control circuit 214 is inverted, the pixel memory 220 stores a value of the count signal at that time. Moreover, the pixel memory 220 outputs, based on a selection signal ϕSEL, the pixel signal stored therein. An example of the pixel memory 220 is SRAM. Further description of the pixel memory 220 will be provided below.

An exemplary operation of one frame of the pixel 112 and the pixel circuit 212 will be described. First, at the start of accumulation in one frame, the pixel control circuit 250 resets the electric charges accumulated in the photoelectric conversion unit 130 by simultaneously supplying the control signal ϕTX and the control signal ϕRST. Then, during the readout at the end of one frame, the pixel control circuit 250 resets the voltage of the accumulation unit 134 to a predetermined voltage by supplying the control signal ϕRST. Subsequently, the pixel control circuit 250 causes the pixel memory 220 to store a value corresponding to the reset voltage of the accumulation unit 134 (DARK conversion), by controlling the control signal ϕ CTL, the reference voltage RAMP, and the count signal to be supplied to the pixel memory 220. Then, the readout control circuit 260 reads out data of the DARK conversion result stored in the pixel memory 220 to the image processing/outputting unit 280 by controlling the selection signal ϕSEL. Further description of the data readout from the pixel memory 220 will be provided below. Moreover, the pixel control circuit 250 transfers the electric charges accumulated in the photoelectric conversion unit 130 to the accumulation unit 134 by supplying the control signal ϕTX. Subsequently, the pixel control circuit 250 causes the pixel memory 220 to store a value corresponding to the voltage of the accumulation unit 134 after the electric charge transfer (SIG conversion), by controlling the control signal ϕ CTL, the reference voltage RAMP, and the count signal to be supplied to the pixel memory 220. Lastly, the readout control circuit 260 reads out data of the SIG conversion result stored in the pixel memory 220 to the image processing/outputting unit 280 by controlling the selection signal ϕSEL.

In the present embodiment, one pixel circuit 212 is provided for one pixel 112, and all the pixels 112 and the pixel circuits 212 are simultaneously controlled. Accordingly, so-called global shutter operation is possible in which a plurality of pixels 112 included in the pixel unit 110 are exposed at the same time. In addition, such an operation in which individual pixels 112 are exposed at different times is also possible.

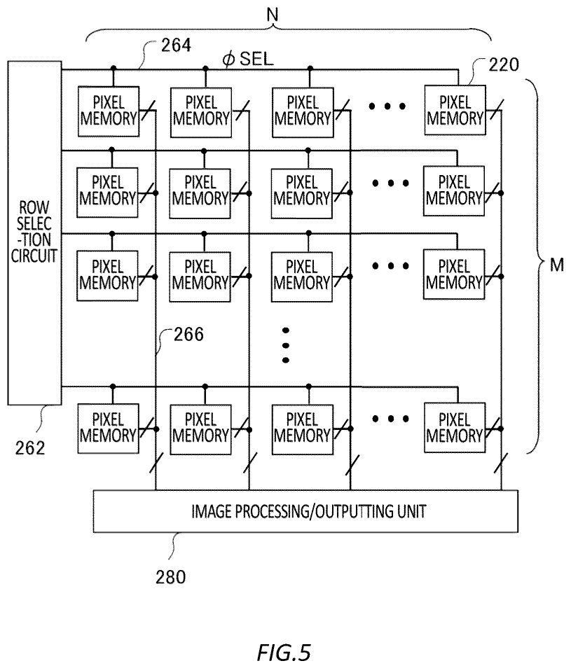

FIG. 5 schematically illustrates a circuit to read out data from the pixel memory 220 to the image processing/outputting unit 280. Components that are not described are omitted in the Figure.

Corresponding to the M×N pixels 121, the M×N pixel memories 220 are disposed. The pixel memories 220 included in each row are connected to a common row selection line 264 of a row selection circuit 262 in the readout control circuit 260. A row selection signal SEL is output to the row selection line 264 as an example of the control signal to read out the pixel signal stored in the pixel memory 220. The row selection line 264 may be referred to as a word selection line.

Meanwhile, the pixel memories 220 included in each column are connected to a common output line 266 to the image processing/outputting unit 280. A pixel signal read out from the pixel memory 220 is output to the output line 266. The output line 266 may be referred to as a bit line.

Here, since the pixel memory 220 stores a digital signal having the number of bits corresponding to gradations or the like of an image signal, the pixel memory 220 includes the number of memory cells according to the number of bits for each pixel 112. For example, if eight bits are used to express the pixel signal of one pixel in 256 levels of gray, then eight memory cells are used. Accordingly, also for outputs from the pixel memory 220, at least the same number of the output lines 266 as the number of bits are used per one column of pixel memories 220, if time division is not applied. In FIG. 5 and thereafter, a diagonal line drawn on a wiring line such as those drawn on the output lines 266 in FIG. 5 indicates that a plurality of wiring lines are represented by one line.

Regarding the readout in the configuration of FIG. 5, the readout operations are performed for many pixel memories 220 at one time, causing a current during the readout to be increased. Therefore, in the present embodiment, the current during the readout is suppressed by using a sense amplifier based on an SRAM scheme.

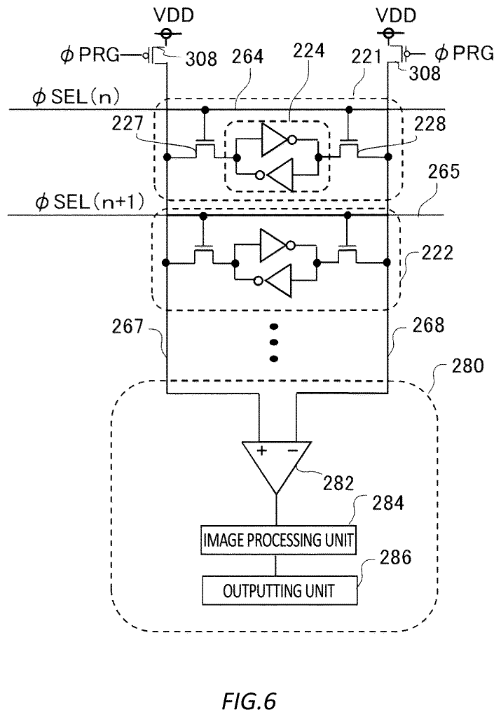

FIG. 6 schematically illustrates, in more detail, the circuit for readout from a memory cell 221. Components that are not described are omitted in the Figure.

The pixel memory 220 corresponding to one pixel 112 includes the number of memory cells corresponding to the number of bits as described above, and FIG. 6 describes a memory cell that corresponds to one of those bits. For the sake of simplicity, a memory cell 221 which is in an nth row and a memory cell 222 which is in an (n+1)th row in one column in M rows and N columns are illustrated. Hereinafter, unless otherwise stated, the illustrated plurality of memory cells store a bit of the same digit of the pixel memories 220 corresponding to the pixels 112 different from each other.

The memory cell 221 includes a flip-flop 224 that holds a value “0” or “1” and transfer gates 227, 228 that are controlled by the row selection signal ϕSEL in the row selection line 264. One end of the transfer gate 227 is connected to the output line 267 and one end of the transfer gate 228 is connected to the output line 268. The memory cell 222 has the same configuration and thus its description is omitted.

The image processing/outputting unit 280 includes a sense amplifier 282 to which the output lines 267, 268 are input, an image processing unit 284 that processes a digital pixel signal based on an output from the sense amplifier 282, and an outputting unit 286 that outputs, to the outside of the chip, the digital pixel signal that has been processed by the image processing unit 284. The sense amplifier 282 is provided at least for each column and for each bit. The output line 267 is connected to the positive input of the sense amplifier 282 and the output line 268 is connected to its negative input. The image processing unit 284 performs correlated double sampling, CDS, for example, by subtracting the DARK conversion result from the SIG conversion result for each pixel. The input portion of the image processing unit 284 may be constituted by a CMOS circuit.

In the configuration shown in FIG. 6, a pair of output lines 267, 268 are provided for each column and for each bit. Accordingly, for the number of bits k, 2 k output lines are provided. Each of the output lines 267, 268 is selectively connected to the voltage VDD through the transistor 308.

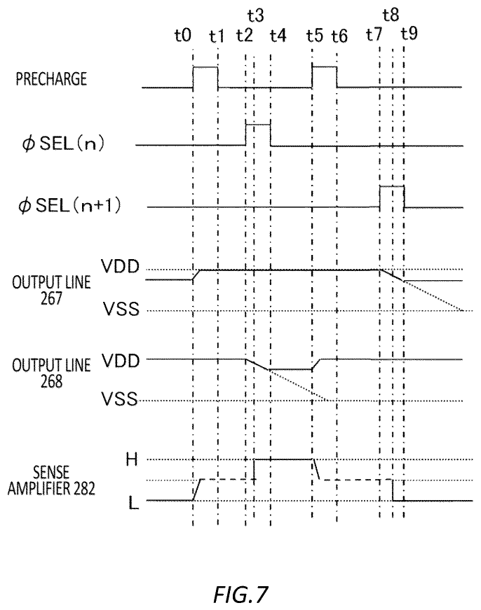

FIG. 7 is an example of a timing chart when reading out the signals stored in the memory cells 221, 222 of FIG. 6. As an example for description, suppose that the memory cell 221 stores a value “1”, and the memory cell 222 stores a value “0”. Note that, the VDD is the higher reference potential, for example, power supply potential, and VSS is the lower reference potential, for example, ground.

First, a precharge signal ϕPRG is supplied from time t0 to t1 to apply the voltage VDD to the output lines 267, 268 for precharging. Note that, by doing so, the output from the sense amplifier 282 turns into an intermediate state (that is, undecided whether it is “H” or “L”).

Subsequently, from time t2 to t4, the row selection signal ϕSEL (n) of High is transmitted from the row selection circuit 262 to the row selection line 264 for a predetermined time period. Thus, the transfer gates 227, 228 in the memory cell 221 in the nth row are turned on for the predetermined time period. In this case, the potential of the output line 267 corresponding to the value “1” does not vary while the potential of the output line 268 corresponding to the value “0” is lowered to the intermediate potential between the VDD and the VSS. The sense amplifier 282 outputs “H” at the time t3 at which a difference between these potentials becomes larger than a preset value. Thus, the value “1” stored in the memory cell 221 in the nth row in the column is read out.

Then, the voltage VDD is again applied to the output lines 267, 268 from time t5 to t6 for precharging. Subsequently, from time t7 to t9, the row selection signal ϕSEL (n+1) of High is transmitted from the row selection circuit 262 to the row selection line 265 for a predetermined time period. Thus, for the memory cell 221 in the (n+1)th row, the potential of the output line 268 corresponding to the value “0” does not vary while the potential of the output line 267 corresponding to the value “1” is lowered to the intermediate potential between the VDD and the VSS. The sense amplifier 282 outputs “L” at the time t8 at which the difference between the potentials becomes larger than the above preset value. Thus, the value “0” stored in the memory cell 222 in the (n+1)th row in the column is read out.

Here, the preset value for the sense amplifier 282 to output “H” or “L” is smaller than the potential difference between the VDD and the VSS, for example, equal to or smaller than 1/10. That is, the sense amplifier 282 functions as a differential amplifier. Accordingly, even if the amplitude of voltage variations in the output lines 267, 268 is smaller than the potential difference between the VDD and the VSS, the sense amplifier 282 can detect the value stored in the memory cell 221. In addition, since the row selection signal ϕSEL becomes Low before any of the voltages in the output lines 267, 268 is lowered to the VSS, the voltage amplitude of the variation in any of the output lines 267, 268 becomes smaller than the potential difference between the VDD and the VSS. Because of this, the amount of current that flows through the output lines 267, 268 during the readout can be made considerably smaller than the amount of current that flows when the potential in the output lines 267, 268 varies from the VDD to the VSS. Accordingly, it is possible to prevent a malfunction caused by a voltage drop even if more pixel memories 220 are disposed, provided that the readout speed is the same. In addition, it is possible to prevent a malfunction caused by a voltage drop even when faster operation is performed, provided that the number of the pixel memories 220 is the same. In addition, in the above-described configuration, the readout speed can be improved since there is no need to wait until the voltage in either of the output lines 267, 268 is lowered to the reference potential VSS.

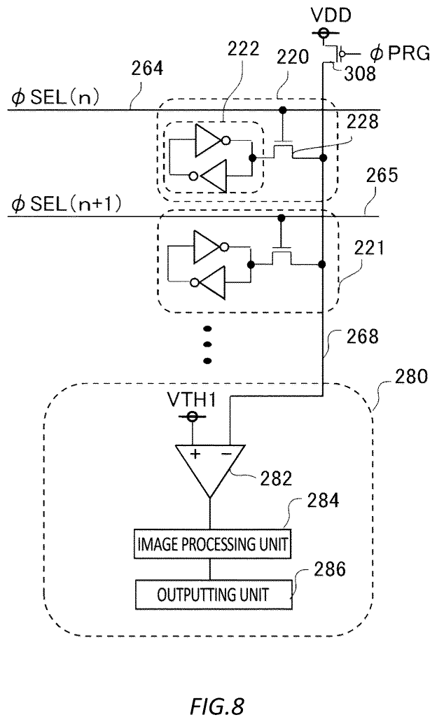

FIG. 8 schematically illustrates, in detail, another circuit for readout from the memory cell 221. In FIG. 8, the same components as those described in FIGS. 1 to 7 are provided with like reference numerals and their descriptions are omitted.

In the example of FIG. 8, the output line 267 in FIG. 6 is not provided, and the output line 268 is connected to the negative input of the sense amplifier 282. As the reference potential, a predetermined voltage VTH1, which is lower than the VDD and higher than the VSS, is applied to the positive input of the sense amplifier 282.

In the above-described configuration, when the selection signal ϕSEL is turned to High after precharging, the sense amplifier 282 outputs “H” if the potential in the output line 268 is lowered, and it outputs “L” if the potential remains at VDD. Accordingly, again in the above-described configuration, it is possible to read out the pixel signal stored in the memory cell 221 with a small amount of current.

Note that, as an alternative to FIG. 8, the output line 268 in FIG. 6 may not be provided, and the output line 267 may be connected to the positive input of the sense amplifier 282. In this case, the VTH1 is connected to the negative input of the sense amplifier 282.

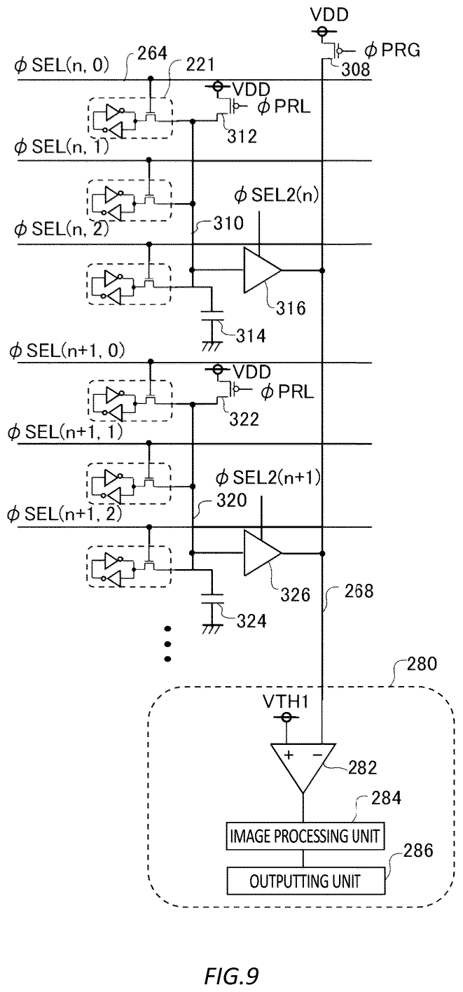

FIG. 9 schematically illustrates, in detail, still another circuit for readout from the memory cell 221. In FIG. 9, the same components as those described in FIGS. 1 to 8 are provided with like reference numerals and their descriptions are omitted.

In FIG. 9, a common output line 310 is connected to multiple memory cells 221 of the plurality of memory cells 221 included in a column. As an example, in FIG. 9, the memory cells 211 in three adjacent rows are connected to the common output line 310. These memory cells 211 are referred to as a memory cell group n. Moreover, in the rows below the memory cell group n, the memory cells 211 in three adjacent rows are connected to another common output line 320. These memory cells 211 are referred to as a memory cell group (n+1).

One end of the output line 310 is connected to the VDD through a transistor 312, and another end is grounded through a capacitor 314. The capacitor 314 may be configured by parasitic capacitance. The output line 310 is connected to an input of a buffer 316, and an output of the buffer 316 is connected to the output line 268. The buffer 316 is a three-state buffer, and is controlled to be in an enabled state by the selection signal ϕSEL2(n), that is, controlled whether it is in a low impedance state or in a high impedance state when outputting. The output line 310, the transistor 312, the capacitor 314, and the buffer 316 operate for the memory cell group n, and thus they can be regarded as a local circuit, so to speak.

Similarly, one end of the output line 320 is connected to the VDD through a transistor 322, and another end is grounded through a capacitor 324. The capacitor 324 may be configured by parasitic capacitance. The output line 320 is connected to an input of a buffer 326, and an output of the buffer 326 is connected to the output line 268. The buffer 326 is a three-state buffer, and is controlled to be in an enabled state by the selection signal ϕSEL2(n+1), that is, controlled whether it is in a low impedance state or in a high impedance state when outputting.

When the pixel signals are to be read out from the memory cell 221, the precharge signal ϕPRL is applied at least to the memory cell group of a readout target to precharge the local output line 310, and the precharge signal ϕPRG is applied to precharge the global output line 268. Then, the selection signal ϕSEL is applied to the memory cell 221 of the readout target, and the selection signal ϕSEL 2 is applied to the memory cell group of the readout target. Thus, the global output line 268 is driven by the high-driving buffer 316, allowing an enhancement of the response speed of the global output line 268. In addition, by shortening the time period during which the selection signal ϕSEL2 is applied, the amplitude of voltage variation in the global output line 268 can be made smaller than the potential difference between the VDD and the VSS, allowing the current to be suppressed which flows when the global output line 268 is charged and discharged.

The number of memory cells 221 included in one memory group is preferably several to several tens, and/or N/1000 to N/100, where N is the number of rows. In addition, the number of memory cells 221 included in one memory group may be powers of two, for simplicity of processing.

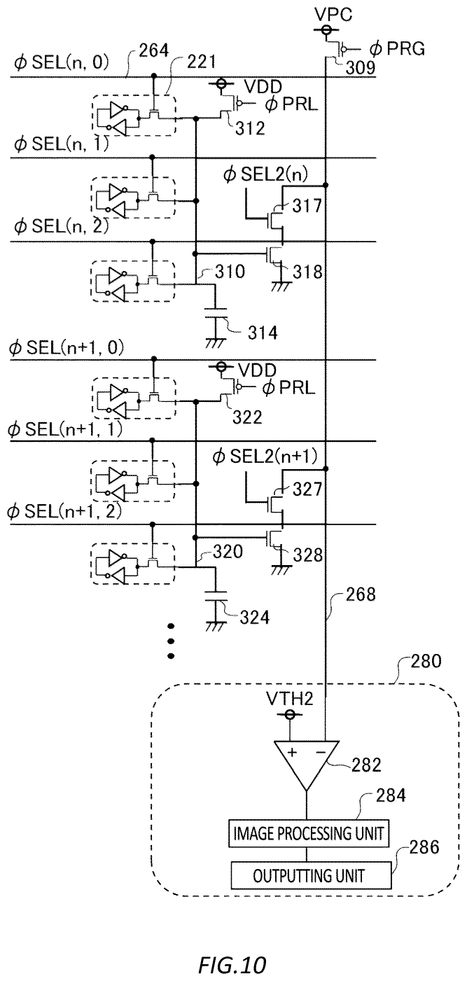

FIG. 10 schematically illustrates, in detail, yet another circuit for readout from the memory cell 221. In FIG. 10, the same components as those described in FIGS. 1 to 9 are provided with like reference numerals and their descriptions are omitted.

Again in FIG. 10, the memory cell group n is connected to the common local output line 310 and the memory cell group (n+1) is connected to the common output line 320, in the same way as FIG. 9. Moreover, instead of the buffer 316 in FIG. 9, transistors 317, 318 are connected between the output line 310 and the output line 268. The transistor 317 is turned on by the selection signal ϕSEL2(n) from the row selection circuit 262. This selection signal can also be regarded as a selection signal to select the memory cell group n.

Similarly, instead of the buffer 326, transistors 327, 328 are connected between the output line 320 and the output line 268. The transistor 327 is turned on by the selection signal ϕSEL2(n+1) from the row selection circuit 262.

One end of the global output line 268 is connected to the voltage VPC through a transistor 309. Here, the VPC is lower than the VDD.

In addition, the sense amplifier 282 is connected to one end of the global output line 268. This configuration is different from that of FIG. 9 in that a predetermined voltage VTH2, which is lower than the VPC and higher than the VSS, is applied to the positive input of the sense amplifier 282.

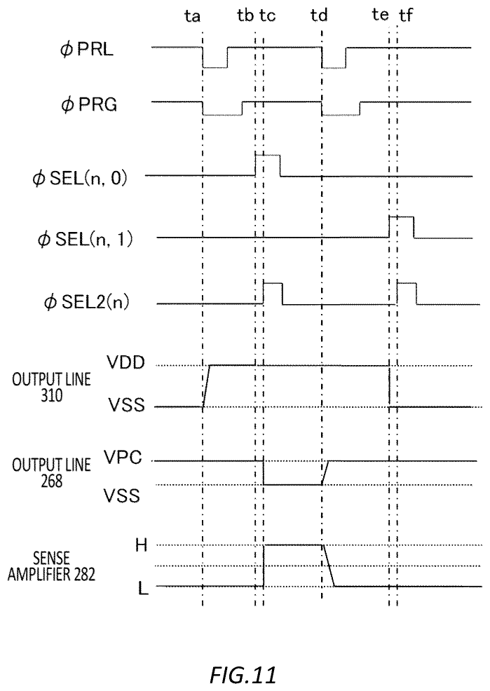

FIG. 11 show an example of a timing chart when reading out the signals stored in the memory cell 221 of FIG. 10. As an example for description, suppose that the memory cell 221 in the first row of the memory group n (that is, (n, 0)th row) stores a value “1”, and the memory cell 221 in the second row of the memory group n (that is, (n, 1)th row) stores a value “0”.

First, at the time ta, the voltage VDD is applied to the output line 310 by the precharge signal ϕPRL and the voltage VPC is applied to the output line 268 by the precharge signal ϕPRG for precharging each. Subsequently, at the time tb, the transfer gate 228 in the memory cell 221 in the (n, 0)th row is turned on by the row selection signal ϕSEL(n, 0) and a value in the memory cell 221 in the (n, 0)th row is output to the local output line 310. In this state, at the time tc, the transistor 317 is turned on by the selection signal ϕSEL2(n) and the value in the memory cell 221 in the (n, 0)th row is output to the global output line 310. In this case, the sense amplifier 282 outputs “H” since the potential in the output line 268 corresponding to the value “0” is lowered. Thus, the value “1” stored in the memory cell 221 in the (n, 0)th row in the column is read out.

Then, at the time td, the voltage VDD is applied to the output line 310 and the voltage VPC is applied to the output line 268 for precharging each. At the time the, the transfer gate 228 in the memory cell 221 in the (n, 1)th row is turned on by the row selection signal ϕSEL(n, 1) and a value in the memory cell 221 in the (n, 1)th row is output to the local output line 310. In this state, at the time tf, the transistor 317 is turned on by the selection signal ϕSEL2(n) and the value in the memory cell 221 in the (n, 1)th row is output to the global output line 310. In this case, the sense amplifier 282 outputs “L” since the potential in the output line 268 corresponding to the value “0” is not lowered. Thus, the value “0” stored in the memory cell 221 in the (n, 1)th row in the column is read out.

Here, the voltage VPC pertaining to the global output line 268 may be lower than the voltage VDD pertaining to the local output line 310. Accordingly, the amount of current that flows through the global output line 268 during the readout can be made considerably smaller.

In addition, amplitude fluctuation of global output line 268 will be described in comparison with the configuration of FIG. 9. In the case of FIG. 9, the voltage amplitude of the voltage in the global output line 268 which varies during the readout is determined by the driving forces of the buffers 316, 326 and the time period during which the selection signal ϕSEL2 is applied. Accordingly, if the driving forces of the buffers 316, 326 fluctuate, the voltage amplitude during the readout of the global output line 268 also fluctuates. Meanwhile, in the configuration of FIG. 10, the voltage amplitude in the global output line 268 during the readout is determined by the difference voltage between the VPC and the VSS, not by the properties of the transistors 317, 318, 327, 328. Accordingly, the fluctuation of the voltage amplitude in the global output line 268 during the readout can be suppressed even if the properties of the transistors 317, 318, 327, 328 fluctuate, allowing simpler design.

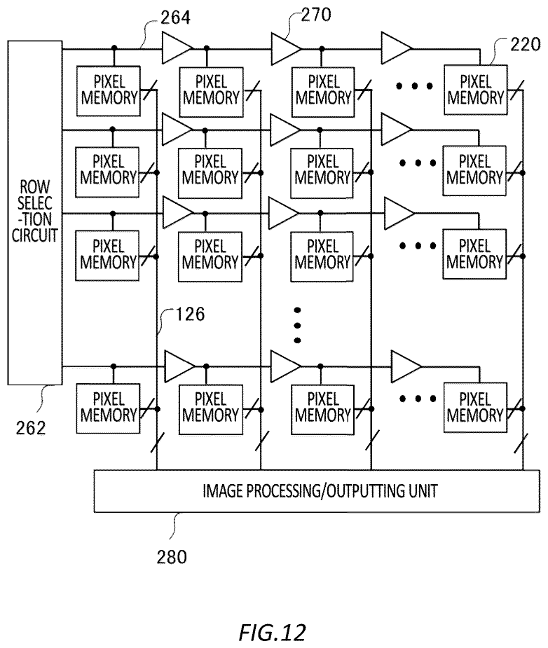

FIG. 12 schematically illustrates another circuit for readout from the pixel memory 220. In FIG. 12, the same components as those described in FIG. 5 are provided with like reference numerals and their descriptions are omitted.

In FIG. 12, a repeater 270 is disposed between the adjacent pixel memories 220 in the row selection line 264. The repeater 270 receives a row selection signal ϕSEL flowing through the row selection line 264 and transfers it forward. Thus, it is possible to suppress the reduction in the response speed by preventing the rising of the row selection signal ϕSEL from becoming less sharp. Note that, the repeater 270 may be disposed at a rate of one per a plurality of pixel memories 220. In addition, the repeater may be disposed in other control lines such as the row selection signal ϕSEL2.

According to the present embodiment, the amount of current that flows during the readout can be made smaller. Note that, in the above-described embodiments, one control circuit 214 is provided for one pixel 112. Alternatively, one control circuit 214 may be provided for a plurality of pixels 112. In this case, supposing that the plurality of pixels 112 corresponding to one control circuit 214 is referred to as a pixel block, the pixel 112 included in one pixel block may be arrayed in m rows and n columns (m is a natural number that is 2 or more and smaller than M, and n is a natural number that is 2 or more and smaller than N), and a plurality of this pixel blocks may be disposed in the row-column direction.

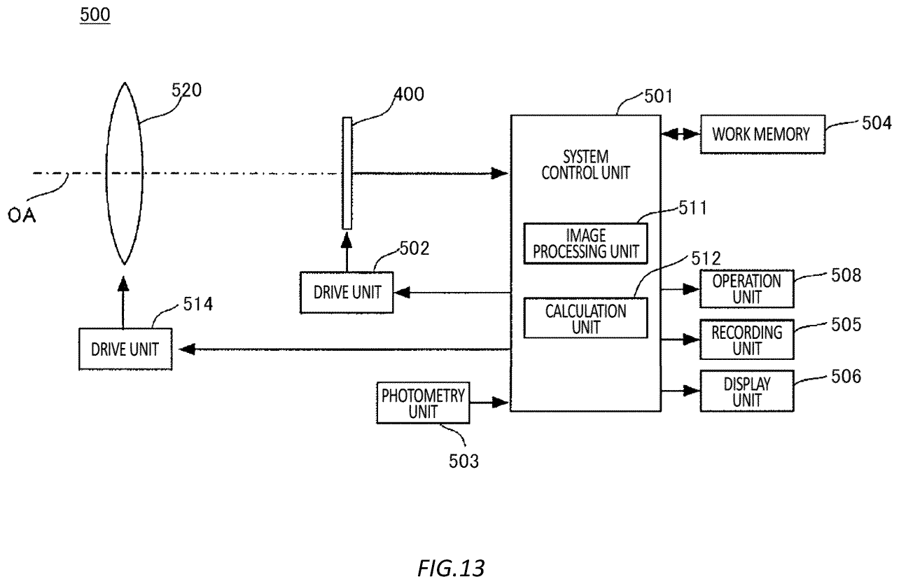

FIG. 13 is a block diagram showing a configuration example of an imaging device 500 according to an embodiment. The imaging device 500 includes the imaging element 400, a system control unit 501, a drive unit 502, a photometry unit 503, a work memory 504, a recording unit 505, a display unit 506, a drive unit 514, and an image taking lens 520.

The image taking lens 520 is configured to guide a subject-emanating light flux incident along an optical axis OA to the imaging element 400. The image taking lens 520 includes a plurality of optical lens groups, and is configured to form an image of the subject-emanating light flux from a scene, in the vicinity of a focal plane of the image taking lens. The image taking lens 520 may be a replaceable lens that can be attached and detached with respect to the imaging device 500. It should be noted that in FIG. 13, the image taking lens 520 is expressed by a single virtual representative lens arranged near the pupil.

The drive unit 514 is configured to drive the image taking lens 520. In an example, the drive unit 514 is configured to move the optical lens group of the image taking lens 520 to change a focusing position. In addition, the drive unit 514 may be configured to drive an iris diaphragm in the image taking lens 520 to control a light amount of the subject-emanating light flux incident on the imaging element 400.

The drive unit 502 has a control circuit configured to execute electric charge accumulating control such as timing control and area control of the imaging element 400 according to instructions from the system control unit 501. In addition, the operation unit 508 is configured to receive an instruction from a photographer using a release button or the like.

The imaging element 400 is configured to transfer pixel signals to an image processing unit 511 of the system control unit 501. The image processing unit 511 is configured to generate image data by performing various image processing using the work memory 504 as a work space. For example, when generating image data of a JPEG file format, compression processing is executed after generating a color video signal from a signal obtained with the Bayer array. The generated image data is recorded in the recording unit 505, converted into a display signal, and displayed on the display unit 506 for a preset time.

The photometry unit 503 is configured to detect a luminance distribution of a scene prior to a series of image taking sequences for generating image data. The photometry unit 503 includes, for example, an AE sensor with approximately one million pixels. A calculation unit 512 of the system control unit 501 is configured to receive an output of the photometry unit 503 and to calculate a luminance for each area of the scene.

The calculation unit 512 is configured to determine a shutter speed, an aperture value, and an ISO sensitivity according to the calculated luminance distribution. The photometry unit 503 may also be used by the imaging element 400. Note that, the calculation unit 512 is also configured to execute various calculations for operating the imaging device 500. The drive unit 502 may be partially or entirely mounted on the imaging element 400. A part of the system control unit 501 may be mounted on the imaging element 400.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

The operations, procedures, steps, stages, or the like of each process performed by a device, system, program, and method shown in the claims, specification, or drawings can be performed in any order as long as the order is not indicated by “prior to,” “before,” or the like and as long as the output from a previous process is not used in a later process. Even if the operation flow is described using phrases such as “first” or “then” in the claims, specification, or drawings, it does not necessarily mean that the process must be performed in this order.

1. An imaging element, comprising:
a storage unit that stores a pixel signal converted into a digital signal;
a control line to which a control signal to read out the pixel signal stored in the storage unit is output;
an output line to which the pixel signal read out from the storage unit is output; and
an amplification unit that amplifies the pixel signal output to the output line.

2. The imaging element according to claim 1, wherein
the output line includes a positive and negative pair of output lines connected to the amplification unit.

3. The imaging element according to claim 1, wherein
the amplification unit is a differential amplification unit.

4. The imaging element according to claim 1, wherein
the output line is connected to one of a positive and negative pair of inputs of the amplification unit, and another of the inputs of the amplification unit is connected to reference potential.

5. The imaging element according to claim 1, further comprising:
a first partial output line to which a pixel signal read out from a plurality of storage units, each being identical to the storage unit, corresponding to a plurality of pixels is output;
a first buffer, an input of which is connected to the first partial output line, and an output of which is connected to the output line;
a second partial output line to which a pixel signal read out from another plurality of storage units, each being identical to the storage unit, corresponding to another plurality of pixels is output; and
a second buffer, an input of which is connected to the second partial output line, and an output of which is connected to the output line.

6. The imaging element according to claim 1, further comprising:
a first partial output line to which a pixel signal read out from a plurality of storage units, each being identical to the storage unit, corresponding to a plurality of pixels is output;
a first selection unit, an input of which is connected to the first partial output line, and an output of which is connected to the output line;
a second partial output line to which a pixel signal read out from another plurality of storage units, each being identical to the storage unit, corresponding to another plurality of pixels is output; and
a second selection unit, an input of which is connected to the second partial output line, and an output of which is connected to the output line, wherein
a voltage applied to the output line is smaller than a voltage applied to the first partial output line and the second partial output line.

7. The imaging element according to claim 1, wherein
the control line is connected to a plurality of storage units in common, each being identical to the storage unit, corresponding to a plurality of pixels, and the imaging element further comprises a repeater that is disposed between the plurality of storage units in the control line and transfers the control signal.

8. An imaging device, comprising the imaging element according to claim 1.
